(19) United States
(12) Patent Application Publication
(10) Pub. No.: US 2016/0200237 A1
(43) Pub. Date: Jul. 14, 2016

(54) CARGO RESTRAINT SYSTEM

(71) Applicant: Hyundai Translead, San Diego, CA (US)

(72) Inventor: Donald James Hindman, San Diego, CA (US)

(21) Appl. No.: 14/593,645

(22) Filed: Jan. 9, 2015

(51) Int. Cl. B60P 7/15; B60P 7/08

(52) U.S. Cl. CPC B60P 7/15; B60P 7/0823; B60P 7/0892

(57) ABSTRACT

Restraining a cargo in a trailer, including: a rolling system configured for a movement within the trailer, the rolling system configured to restrain the cargo, when fixed in position; a track system configured to enable the movement of the rolling system; and a latch system configured to fix the rolling system in position.

### BACKGROUND

1. Field of the Invention

The present invention relates to a system for restraining cargo, and more specifically, to a rolling-type restraining system.

2. Background

In cargo trailers, the load needs to be secured during transport to reduce undesired shifting and damage to the load. In a conventional trailer, container, or boxcar, load restraint enclosures can be secured to the floor or sides using specially fabricated wood framing, floor blocking, rubber mats, steel strapping, or heavy air bags. These conventional means for securing the load have limitations associated with construction cost and lack of strength sufficient to secure heavy load. Further, a trailer may be used for shipping where only a partial load is carried, and the load is positioned within a central location of the trailer. In this case, it may be impractical to construct wooden front and rear restraint enclosures sufficient to secure the load where the front of the trailer is not utilized.

### SUMMARY

The present invention provides for securing a load in vehicles such as trailers, containers, or boxcars.

In one implementation, a moveable cargo restraint system for restraining a cargo in a trailer is disclosed. The system includes: a rolling system configured for a movement within the trailer, the rolling system configured to restrain the cargo, when fixed in position; a track system configured to enable the movement of the rolling system; and a latch system configured to fix the rolling system in position.

In another implementation, an apparatus for restraining a cargo in a trailer is disclosed. The apparatus includes: means for restraining the cargo within the trailer, when fixed in position; means for enabling the movement of the means for restraining; and means for fixing the means for restraining in position.

Other features and advantages of the present invention should be apparent from the present description which illustrates, by way of example, aspects of the invention.

### BRIEF DESCRIPTION OF THE DRAWINGS

The details of the present invention, both as to its structure and operation, may be gleaned in part by study of the appended further drawings, in which like reference numerals refer to like parts, and in which:

FIG. 1 is a partial rear view of a trailer showing a moveable cargo restraint system in accordance with one embodiment of the present disclosure;

FIG. 2 is a detailed view of the side-wall-mounted track system coupled to the upper member of the rolling system in accordance with one embodiment of the present disclosure;

FIG. 3 is a detailed view of the track and the trolley in accordance with another embodiment of the present disclosure;

FIG. 4 is a partial view of each of a set of straps coupled to an attachment ring in accordance with another embodiment of the present disclosure;

FIG. 5 is a detailed view of the latch system in accordance with one embodiment of the present disclosure; and

FIG. 6 is another partial rear view of a trailer showing a moveable cargo restraint system in accordance with another embodiment of the present disclosure.

### DETAILED DESCRIPTION

To overcome the difficulties of securing the load in vehicles such as trailers, containers, or boxcars, several embodiments of a moveable cargo restraint system are proposed. In one embodiment, the moveable cargo restraint system enables repositioning of restraints when partial loads are present in the vehicle.

After reading this description it will become apparent how to implement the invention in various implementations and applications. However, although various implementations of the present invention will be described herein, it is understood that these implementations are presented by way of example only, and not limitation. As such, this detailed description of various implementations should not be construed to limit the scope or breadth of the present invention.

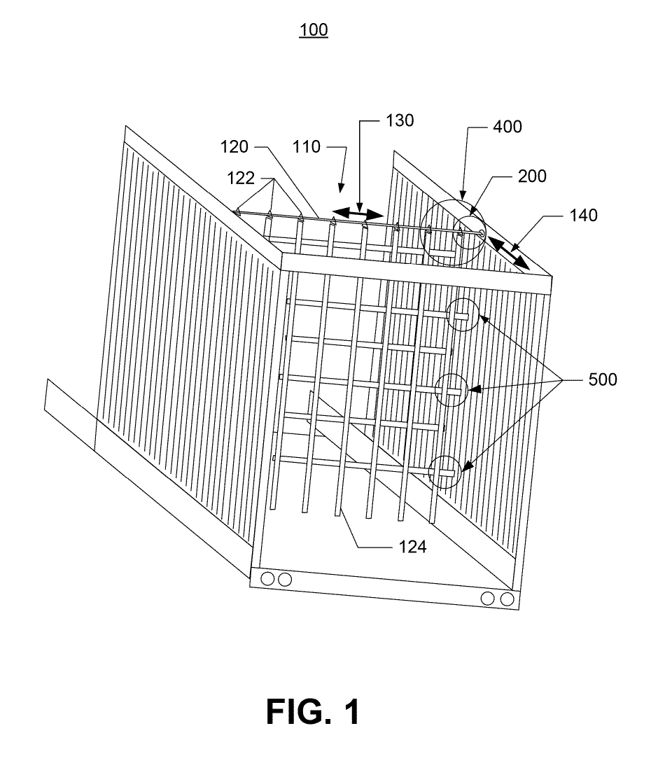

FIG. 1 is a partial rear view of a trailer showing a moveable cargo restraint system 100 in accordance with one embodiment of the present disclosure. In the illustrated embodiment of FIG. 1, the moveable cargo restraint system 100 includes a rolling system 110, a side-wall-mounted track system 200, and a latch system 500 for latching the rolling system 110 onto the side walls of a trailer.

In one embodiment, the rolling system 110 includes an upper member 120, a plurality of attachment rings 122, and a set of straps, netting, or resilient lattice work 124 (hereinafter referred to as “set of straps”). In the illustrated embodiment, the upper member 120 is configured as a bar that stretches from one side wall to another side wall of the trailer. Thus, the upper member 120 is installed onto the side-wall mounted track system 200 using fore and aft rollers on both side walls of the trailer with the upper member 120 separating these pairs of rollers. The upper member 120 is used to hold and guide the set of straps 124 which can be collapsed by sliding (i.e., movement 130) the straps 124 and the attachment rings 122 along the upper member 120, thus placing them on one side or the other for storage. Thus, the rolling system 110 can be readily stored by sliding or collapsing the flexible set of straps to one side of the trailer and securing or tying down the straps.

The upper member 120 is further configured to space the trolleys and hold them apart at a specific distance while the rolling system 110 is moved back and forth (i.e., movement 140) in the trailer throughout its range. While in use, the set of straps 124 is extended from side to side inside the trailer and rolled to a required position. The set of straps 124 is then latched to a pre-determined location within the latch system 500. Once the set of straps 124 is latched, the straps form a barrier that prevents shifting of the load/cargo from the pallet or loading point.

The moveable cargo restraint system 100, when properly fixed using the set of straps 124 and the latch system 500, prevents the cargo or load from scattering inside the trailer. This reduces cargo damage and injury from moving and/or toppling loads. Further, the moveable cargo restraint system 100 maintains a consistent location of the upper member 120 which provides ease of repositioning of the rolling system 110 such that a warehouse person of any height can move the rolling system 110 by simply sliding the upper member 120 to the desired position.

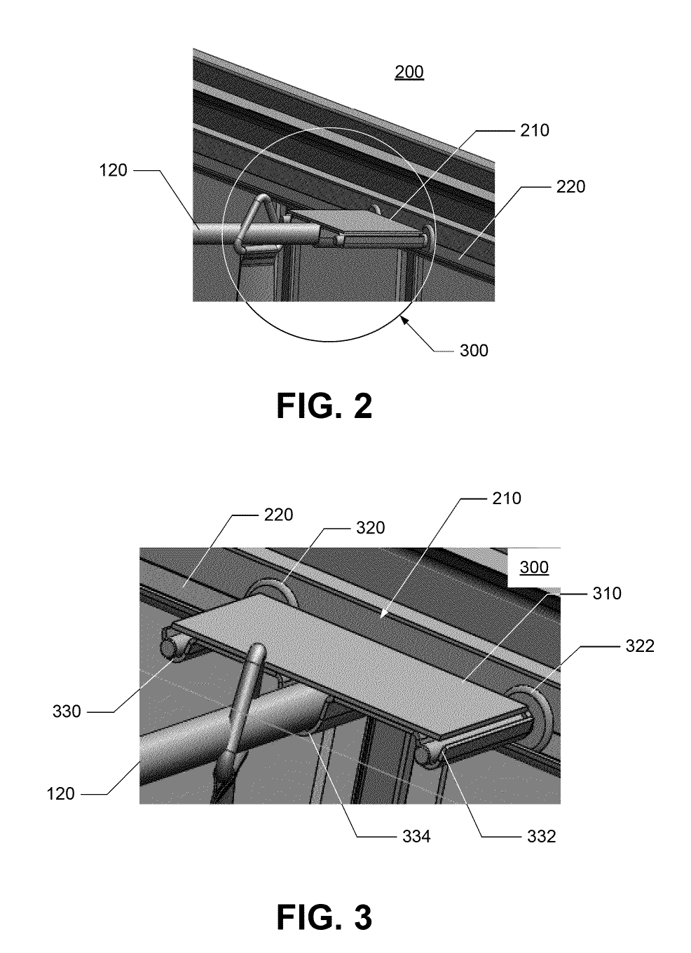

FIG. 2 is a detailed view of the side-wall-mounted track system 200 coupled to the upper member 120 of the rolling system 110 in accordance with one embodiment of the present disclosure. The side-wall-mounted track system 200 includes a pair of tracks 220 and a pair of trolleys 210. A further detailed view 300 of the track 220 and the trolley 210 is illustrated in FIG. 3.

In the illustrated embodiment of FIG. 2, a track 220 is affixed to each of the side walls of the trailer to guide a trolley 210 to move back and forth, while the trolley 210 includes a platform with an attachment to couple the upper member 120 and wheels for sliding along the track 220. In other embodiments, the side-wall-mounted track system 200 can be configured differently than as shown in FIG. 2, as long as the system enables the upper member 120 to slide or move along the upper side walls so that the rolling system 110 can be moved back and forth in the trailer.

FIG. 3 is a detailed view 300 of the track 220 and the trolley 210 in accordance with another embodiment of the present disclosure. In the illustrated embodiment of FIG. 3, the trolley 210 further includes a platform 310 coupled to an attachment which forms openings 330, 332, 334 to accept the upper member 120 and axles for front and back wheels 320, 322. The front wheel axle inserts into opening 330, the back wheel axle inserts into opening 332, and the upper member 120 inserts into opening 334. This configuration enables the upper member 120 to smoothly slide along the upper part of the trailer and enables the rolling system 110 to be repositioned to precisely restrain the cargo or load. In other embodiments, the trolley 210 and the track 220 can be configured differently than as shown in FIG. 3, as long as the trolley 210 and the track 220 enable the upper member 120 to slide or move along the upper side walls so that the rolling system 110 can be moved back and forth in the trailer.

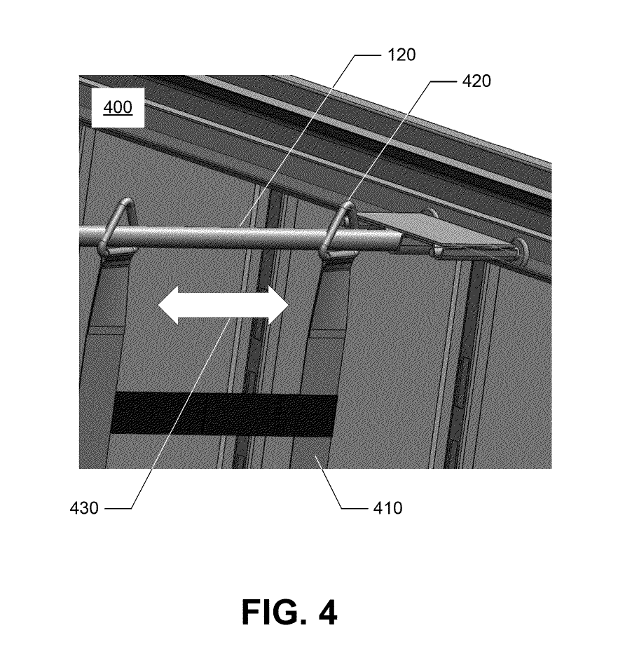

FIG. 4 is a partial view 400 of each of a set of straps 410 coupled to an attachment ring 420 in accordance with another embodiment of the present disclosure. In the illustrated embodiment of FIG. 4, each of the set of straps 410 is coupled to an attachment ring 420, which hooks onto the upper member 120. As mentioned above, the upper member 120 is used to hold and guide the set of straps 410 which can be collapsed by sliding (i.e., movement 430) the straps 410 and the attachment rings 420 along the upper member 120, thus placing them on one side or the other for storage. The set of straps 410 that has been placed on one side can be secured or tied down in one corner.

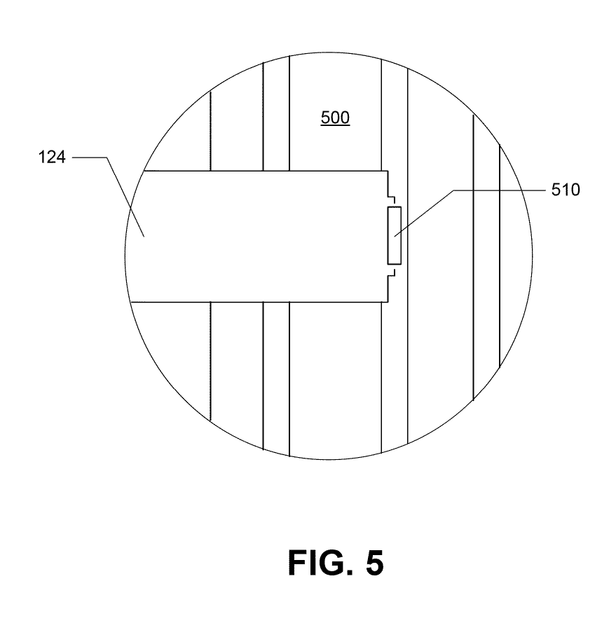

FIG. 5 is a detailed view of the latch system 500 in accordance with one embodiment of the present disclosure. In the illustrated embodiment of FIG. 5, the latch system 500 is configured to latch the set of straps 124 of the rolling system 110 onto the side walls of the trailer. The set of straps 124 is latched to a pre-determined location 510 within the latch system 500 of the side walls. Once each of the set of straps 124 is latched to a pre-determined location 510 on the side wall, the straps form a barrier that prevents shifting of the load/cargo from the pallet or loading point.

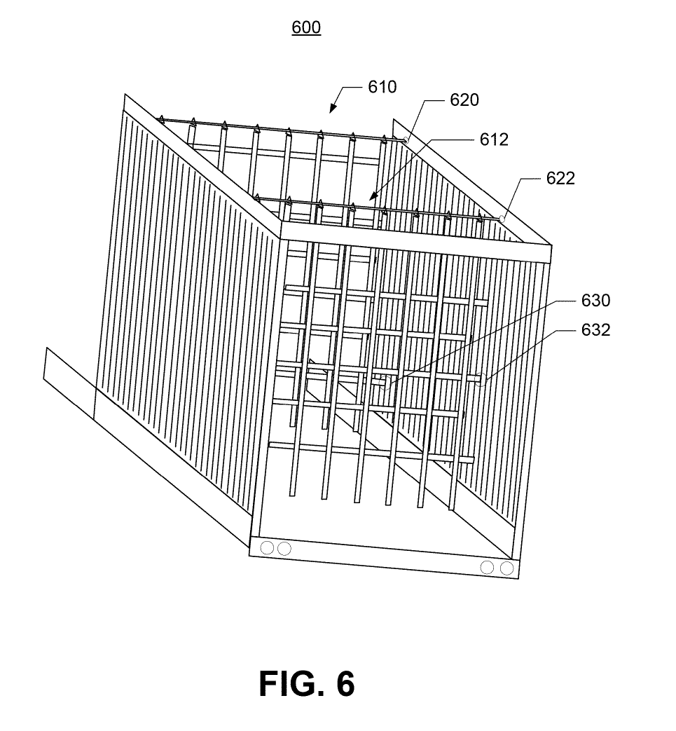

FIG. 6 is another partial rear view of a trailer showing a moveable cargo restraint system 600 in accordance with another embodiment of the present disclosure. In the illustrated embodiment of FIG. 6, the moveable cargo restraint system 600 includes a plurality of rolling systems 610, 612, a plurality of side-wall-mounted track systems 620, 622, and a plurality of latch systems 630, 632 for latching the rolling systems 610, 612 onto the side walls of a trailer. In this embodiment, each of the plurality of sets of straps 124 is latched to a pre-determined location within the side wall. Once the plurality of sets of straps 124 is latched, the straps form barriers on both sides of the load/cargo to prevent shifting of the load/cargo from the pallet or loading point. The moveable cargo restraint system 100 in this configuration can prevent the cargo or load situated in the middle of the trailer from scattering inside the trailer.

The above description of the disclosed implementations is provided to enable any person skilled in the art to make or use the invention. Various modifications to these implementations will be readily apparent to those skilled in the art, and the generic principles described herein can be applied to other embodiments without departing from the spirit or scope of the invention. For example, while the implementations above focus on using the moveable cargo restraint system 100, 600 within a trailer, the system 100, 600 can be used in other forms of transportation such as containers, boxcars, or vans. Further, the rolling system 110, 610, 612 can use means other than the strap of sturdy material. For example, the rolling system 110, 610 can use strands of steel or wire. Thus, it is to be understood that the description and drawings presented herein represent a presently preferred embodiment of the invention and are therefore representative of the subject matter that is broadly contemplated by the present invention. It is further understood that the scope of the present invention fully encompasses other embodiments that may become obvious to those skilled in the art and that the scope of the present invention is accordingly limited by nothing other than the appended claims.

1. A moveable cargo restraint system for restraining a cargo in a trailer, the system comprising:
a rolling system configured for a movement within the trailer, the rolling system configured to restrain the cargo, when fixed in position;
a track system configured to enable the movement of the rolling system; and
a latch system configured to fix the rolling system in position.

2. The system of claim 1, wherein the rolling system comprises:
an upper member;
a plurality of attachment rings coupled to the upper member; and
a set of straps coupled to the upper member through the plurality of attachment rings.

3. The system of claim 2, wherein the upper member is a bar that stretches from one side wall to another side wall of the trailer.

4. The system of claim 2, wherein the track system comprises:
a pair of trolleys, each trolley configured to accept one end of the upper member; and
a pair of tracks, each track affixed to each of side walls of the trailer to guide said each trolley to enable the movement of the rolling system.

5. The system of claim 4, wherein said each trolley comprises
first and second rollers for sliding along said each track.

6. The system of claim 4, wherein said each trolley further comprises
a platform with an attachment to couple the upper member and the first and second roller.

7. The system of claim 2, wherein the latch system comprises
a latching device configured to latch the set of straps onto side walls of the trailer,
wherein latching the set of straps fixes the rolling system in position.

8. The system of claim 2, further comprising
a securing mechanism configured to tie the set of straps after collapsing the set of straps to one side of the trailer for storage.

9. An apparatus for restraining a cargo in a trailer, the apparatus comprising:
means for restraining the cargo within the trailer, when fixed in position;
means for enabling the movement of the means for restraining; and
means for fixing the means for restraining in position.

10. The apparatus of claim 1, wherein the means for restraining comprises:
means for strapping the cargo;
means for laterally moving the means for strapping; and
means for coupling the means for strapping to the means for laterally moving.

11. The apparatus of claim 10, wherein the means for coupling is a bar that stretches from one side wall to another side wall of the trailer.

12. The apparatus of claim 10, wherein the means for enabling comprises:
a pair of trolleys, each trolley configured to accept one end of the upper member; and
a pair of tracks, each track affixed to each of side walls of the trailer to guide said each trolley to enable the movement of the rolling system.

13. The apparatus of claim 12, wherein said each trolley comprises
means for sliding along said each track.

14. The apparatus of claim 12, wherein said each trolley further comprises
means for coupling the upper member and the means for sliding.

15. The apparatus of claim 10, wherein the means for fixing comprises
means for latching the means for strapping onto side walls of the trailer,
wherein the means for latching fixes the means for restraining in position.

16. The apparatus of claim 10, further comprising
means for securing configured to tie the means for strapping after collapsing the means for strapping to one side of the trailer for storage.
